(19) United States
(12) Patent Application Publication
(10) Pub. No.: US 2025/0255769 A1
(43) Pub. Date: Aug. 14, 2025

(54) WALKER APPARATUS WITH WEIGHT SENSOR

(71) Applicants: Michael Roufaeal, Succasunna, NJ (US); Jalpen Shah, Succasunna, NJ (US)

(72) Inventors: Michael Roufaeal, Succasunna, NJ (US); Jalpen Shah, Succasunna, NJ (US)

(21) Appl. No.: 18/441,153

(22) Filed: Feb. 14, 2024

(51) Int. Cl. A61H 3/04; G08B 21/04

(52) U.S. Cl. CPC A61H 3/04; G08B 21/0461; A61H 2201/0161; A61H 2201/0188; A61H 2201/0192; A61H 2201/1635; A61H 2201/1664; A61H 2201/1671; A61H 2201/1676; A61H 2201/5007; A61H 2201/5023; A61H 2201/5043; A61H 2201/5048; A61H 2201/5058; A61H 2201/5069; A61H 2201/5084; A61H 2201/5092; A61H 2201/5097

(57) ABSTRACT

A walker apparatus for detecting when a user of the walker exerts too much weight downwardly onto the walker includes a support frame, a load sensor, and a feedback assembly. The support frame is grasped by a user to balance the user on a support surface. The load sensor detects a compressive load exerted vertically on the support frame. The feedback assembly generates a feedback signal perceivable by the user to notify the user when too much weight is exerted on the support frame.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to walkers and more particularly pertains to a new walker for detecting when a user of the walker exerts too much weight downwardly onto the walker.

### (2) Description of Related Art Including Information Disclosed Under 37 CFR 1.97 and 1.98

A common problem users of walkers encounter during use of a walker is relying too much on the walker to support the weight of the user. Walkers are primarily intended to help users balance rather than supporting their weight. Furthermore, heavy reliance on a walker to support the weight of a user can lead to postural conditions which are deleterious to the health of the user. The prior art describes walkers which aid users in developing proper gaits when using the walkers, but the prior art fails in disclosing such an apparatus which notifies the user that too much weight is being exerted onto the walker. A new apparatus which provides this information to the user would be advantageous in training the user to properly use the walker such that postural issues are avoided.

### BRIEF SUMMARY OF THE INVENTION

An embodiment of the disclosure meets the needs presented above by generally comprising a support frame with a front panel, a pair of lateral supports, and a pair of grips. Each lateral support is coupled to the front panel and is positioned on an associated end of a pair of ends of the front panel. Each grip is coupled to a top side of an associated lateral support of the pair of lateral supports. A processor is mounted to the support frame, and a pair of load sensors is operatively coupled to the processor. Each load sensor of the pair of load sensors is mounted to an associated lateral support of the pair of lateral supports. The pair of load sensors is configured to detect a compressive load exerted vertically on the support frame, and the processor is programmed to determine when the compressive load is greater than a threshold load. The threshold load is selected to have a magnitude is less than a weight of a user and is considered to be too high a proportion of the weight of the user to be placing on the support frame. A feedback assembly is operatively coupled to the processor and is programmed to generate a feedback signal indicative of the compressive load is greater than the threshold load via the feedback assembly.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a walker apparatus according to an embodiment of the disclosure.

FIG. 2 is a front view of an embodiment of the disclosure.

FIG. 3 is a side view of an embodiment of the disclosure.

FIG. 4 is a back view of an embodiment of the disclosure.

FIG. 5 is a detail view of an embodiment of the disclosure taken from Circle 5 in FIG. 3.

FIG. 6 is a detail perspective view of an embodiment of the disclosure taken from Circle 6 in FIG. 1.

FIG. 7 is a detail side view of a force sensor of an embodiment of the disclosure.

FIG. 8 is an in-use view of an embodiment of the disclosure.

FIG. 9 is a block diagram of an embodiment of the disclosure.

### DETAILED DESCRIPTION OF THE INVENTION

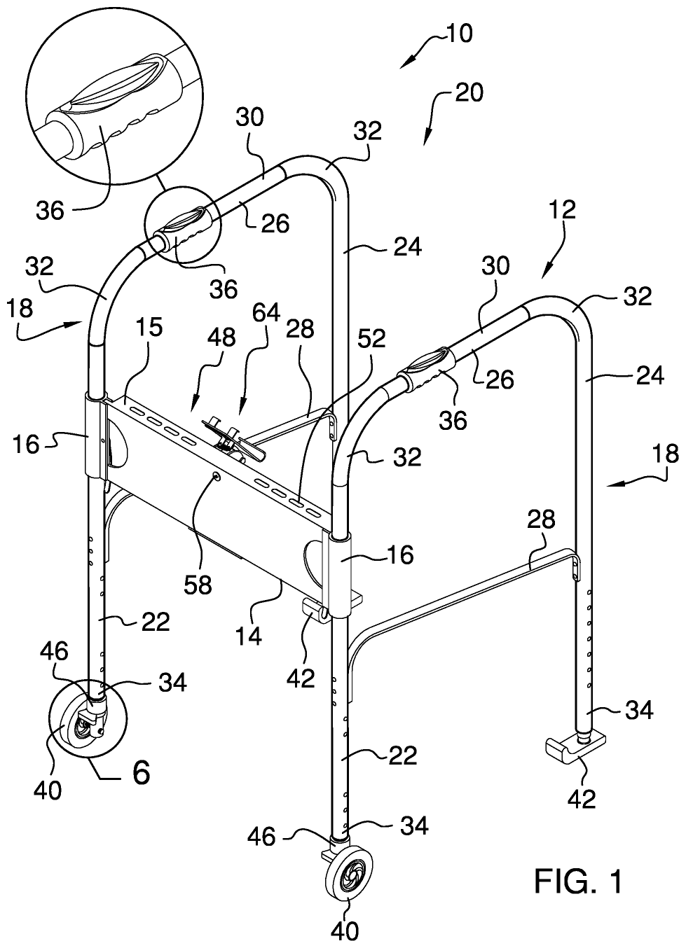

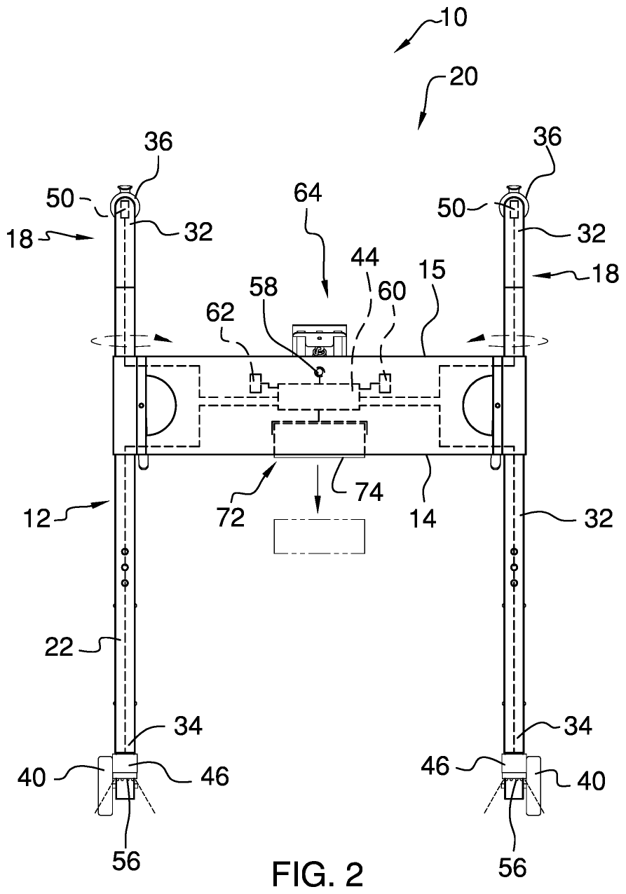

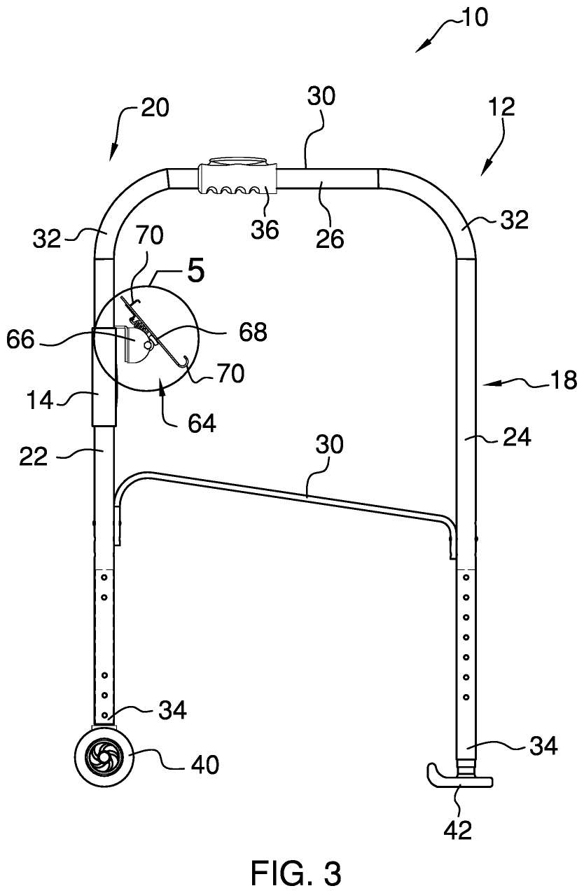

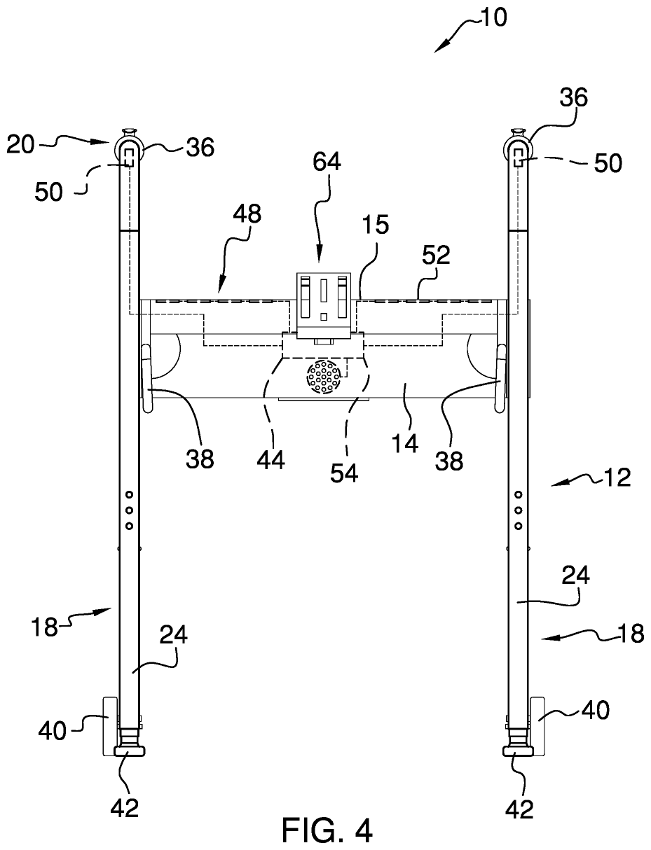

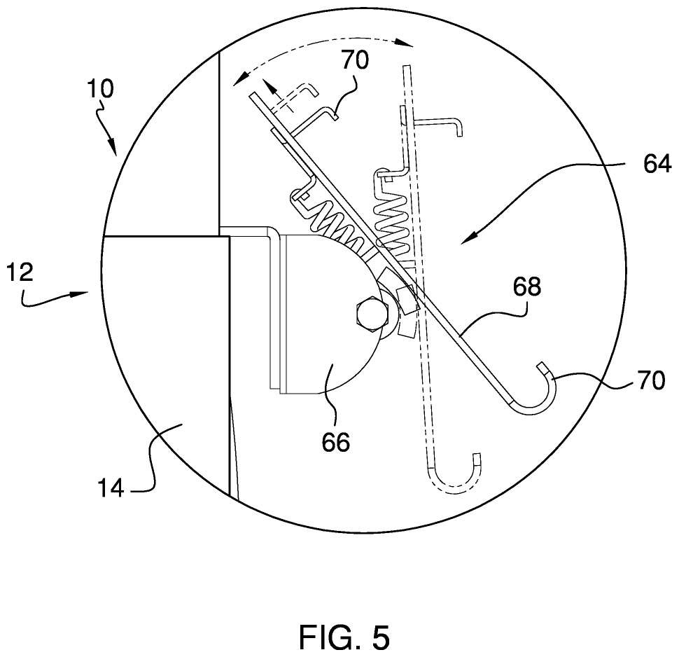

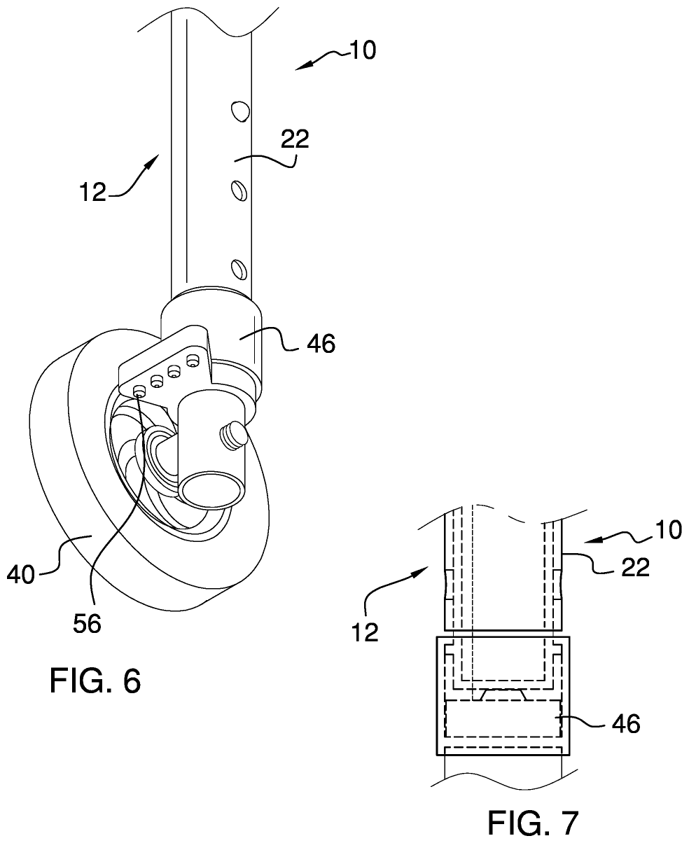

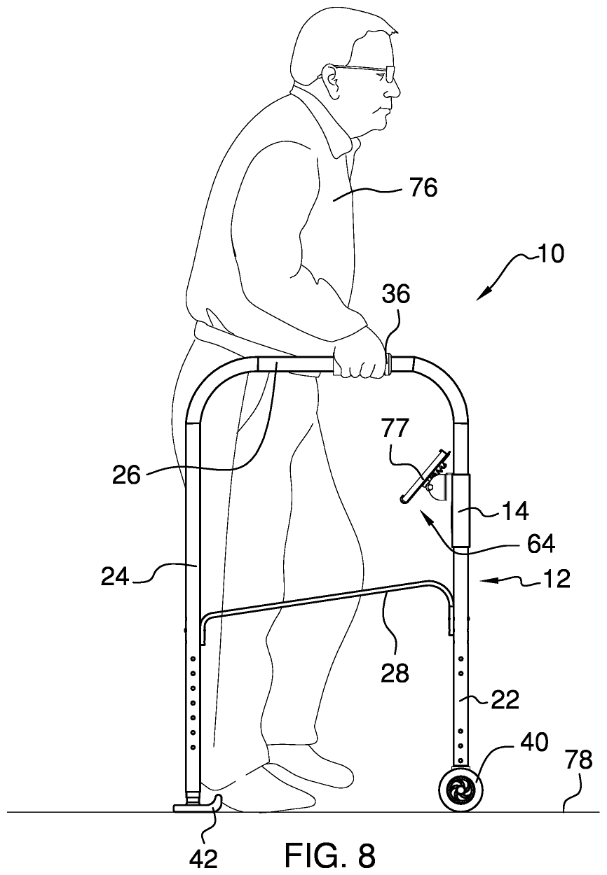

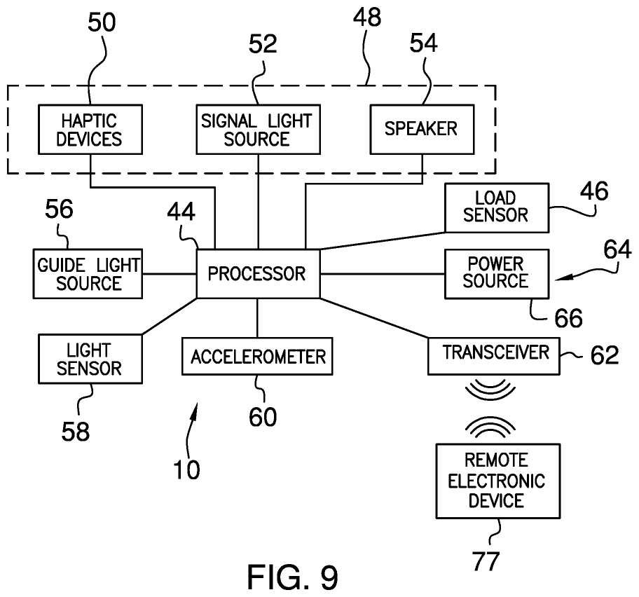

With reference now to the drawings, and in particular to FIGS. 1 through 8 thereof, a new walker embodying the principles and concepts of an embodiment of the disclosure and generally designated by the reference numeral 10 will be described.

As best illustrated in FIGS. 1 through 8, the walker apparatus 10 generally comprises a support frame 12 which has a front panel 14 and a pair of lateral supports 18. Each lateral support 18 of the pair of lateral supports 18 is coupled to the front panel 14 and is positioned on an associated end 16 of a pair of ends 16 of the front panel 14. The lateral supports 18 are pivotable between a deployed configuration 20 wherein each lateral support 18 extends rearwardly from the front panel 14 and a folded configuration (not shown) wherein the lateral supports 18 extend toward each other. Each lateral support 18 of the pair of lateral supports 18 comprises a front leg 22, a rear leg 24, an upper crossbar 26, and a lower crossbar 28. The upper crossbar 26 is coupled to and extends between upper ends 32 of the front leg 22 and the rear leg 24. The lower crossbar 28 is coupled to and extends between the front leg 22 and the rear leg 24 below the upper crossbar 26. Each of the front leg 22 and the rear leg 24 is telescopically adjustable. Spring buttons, locking pins, or the like may be provided for securing the front leg 22 and the rear leg 24 in selected lengths.

The support frame 12 further includes a pair of grips 36 and a pair of support securement members 38. Each grip 36 is coupled to a top side 30 of an associated lateral support 18 of the pair of lateral supports 18. Each support securement member 38 of the pair of support securement members 38 is mounted to the front panel 14 and is engageable with an associated lateral support 18 of the pair of lateral supports 18 to secure the associated lateral support 18 with respect to the front panel 14. Each support securement member 38 of the pair of support securement members 38 is rotatable with respect to the front panel 14 to engage the associated lateral support 18 in a clamping action. The support securement members 38 also may comprise spring buttons, locking pins, latches, or the like.

The support frame 12 also has a pair of wheels 40 and a pair of skids 42 to facilitate moving the support frame 12 across a support surface 78. Each wheel 40 of the pair of wheels 40 is rotatably coupled to a lower end 34 of the front leg 22 of an associated lateral support 18 of the pair of lateral supports 18. Each wheel 40 of the pair of wheels 40 comprises a resiliently compressible material such that the wheel 40 is configured to conform to a shape of an obstruction. The resiliently compressible material may comprise rubber, for example, or silicone, a polymer foam, or the like. The wheels 40 may also have a size which facilitates moving the wheels 40 over the obstruction when the wheels 40 approach the obstruction in a direction parallel to the support surface 78. Each wheel 40 of the pair of wheels 40 defines a tread to frictionally enhance the wheel 40. Each skid 42 of the pair of skids 42 is mounted to a lower end 34 of the rear leg 24 of an associated lateral support 18 of the pair of lateral supports 18. In some embodiments, only a plurality of wheels 40 or only a plurality of skids 42 may be provided.

A processor 44 is mounted to the support frame 12 and is positioned in the front panel 14. A pair of load sensors 46 is operatively coupled to the processor 44. Each load sensor 46 is mounted to the lower end 34 of the front leg 22 of an associated lateral support 18 of the pair of lateral supports 18. The load sensors 46 are configured to detect a compressive load exerted vertically on the support frame 12, and the processor 44 is programmed to determine when the compressive load is greater than a threshold load. The load sensors 46 may comprise metal foil strain gauges or other force transducers. The threshold load is selected to have a magnitude is less than a weight of a user 76 and is considered to be too high a proportion of the weight of the user 76 to be placing on the support frame 12. The threshold load may be a constant value, such as 10.0 pounds for example. The threshold load also may be selected by a manufacturer or the user 76.

A feedback assembly 48 is operatively coupled to the processor 44 and is programmed to generate a feedback signal indicative of the compressive load being greater than the threshold load via the feedback assembly 48. The feedback assembly 48 comprises a pair of haptic devices 50, a signal light source 52, and a speaker 54. Each haptic device 50 is mounted in an associated grip 36 of the pair of grips 36 and is configured to generate a tactile signal to be sensed by a hand of the user 76. The haptic devices 50 may comprise eccentric rotating mass actuators, piezoelectric actuators, or other actuator to produce a vibration, a nudge, or another action which is detectable by the user 76 via touch. The signal light source 52 is mounted to an upper edge 15 of the front panel 14 and is configured to emit a visible signal. The speaker 54 is mounted to the front panel 14 and is configured to emit an audible signal. The feedback signal may use one or more of the pair of haptic devices 50, the signal light source 52, and the speaker 54, and the processor 44 may be programmed to receive selections from the user 76 as to which of the pair of haptic devices 50, the signal light source 52, and the speaker 54 is used to generate the feedback signal.

A pair of guide light sources 56 is operatively coupled to the processor 44. Each guide light source 56 is coupled to the lower end 34 of the front leg 22 of an associated lateral support 18 of the pair of lateral supports 18. The pair of guide light sources 56 is configured to emit light forwardly of the pair of wheels 40. A light sensor 58 is operatively coupled to the processor 44 and is mounted to the front panel 14. The processor 44 is programmed to activate the pair of guide light sources 56 when the light sensor 58 detects a low brightness level. The low brightness level is selected to have a brightness at which the user 76 has difficulty visually observing the environment around the user 76. In some embodiments, the guide light sources 56 also may be manually operable by the user 76.

An accelerometer 60 is operatively coupled to the processor 44 and is mounted to the support frame 12. The processor 44 is programmed to cause the feedback assembly 48 to generate an alert signal when the accelerometer 60 detects a tipping motion of the support frame 12. The alert signal may be identical to the feedback signal or may be distinct. The processor 44 may be programmed to receive selections from the user 76 as to which of the pair of haptic devices 50, the signal light source 52, and the speaker 54 is used to generate the alert signal.

A transceiver of 62 is operatively coupled to the processor 44 wherein the processor 44 is configured to wirelessly communicate with a remote electronic device 77, which may be a smartphone, a tablet, a computer, or the like. The remote electronic device 77 may have instructions for receiving instructions from the user 76 to send to the processor 44 in order to control the processor 44. The transceiver of 62 may communicate with the remote electronic device 77 via any suitable wireless network including, for example, a personal area network following a Bluetooth® communications protocol.

A device mount 64 is coupled to a rear side of the front panel 14 and comprises a base 66 and a clamp 68. The base 66 is coupled to the front panel 14, and the clamp 68 is pivotally coupled to the base 66. The clamp 68 comprises a pair of hooks 70 which are biased to move toward each other to clamp and hold the remote electronic device 77. The clamp 68 may be secured in a selected position via friction with the base 66 or securement means such as a latch, a locking pin, or the like. The device mount 64 may also secure the remote electronic device 77 via a snap fit, a cradle, or the like.

In some embodiments, a separate display screen may be mounted to the support frame 12 and be operatively coupled to the processor 44. An input, which may be incorporated into the separate display screen, may also be mounted to the support frame 12 and operatively coupled to the processor 44. The input may comprise a touchscreen, a keypad, or the like. A power source 72 is electrically couplable to the processor 44 and is removably mountable to the front panel 14 to electrically couple to the processor 44. The power source 72 comprises a battery 74.

In use, the support frame 12 is used by the user 76 to facilitate balancing the user 76 above the support surface 78 while the user 76 walks across or stands upon the support surface 78. When the force sensors detect that the compressive load is greater than the threshold load, the feedback signal is generated via the feedback assembly 48, notifying the user 76 to decrease the amount of weight the user 76 is placing on the support surface 78. When the light sensor 58 detects the low brightness level, the processor 44 activates the guide light sources 56. When the accelerometer 60 detects the tipping motion, the processor 44 activates the feedback assembly 48 to generate the alert signal.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A walker apparatus comprising:
a support frame comprising:
a front panel;
a pair of lateral supports being coupled to the front panel, each lateral support of the pair of lateral supports being positioned on an associated end of a pair of ends of the front panel; and
a pair of grips, each grip being coupled to a top side of an associated lateral support of the pair of lateral supports;
a processor being mounted to the support frame;
a pair of load sensors being operatively coupled to the processor, each load sensor of the pair of load sensors being mounted to an associated lateral support of the pair of lateral supports, the pair of load sensors being configured to detect a compressive load exerted vertically on the support frame, the processor being programmed to determine when the compressive load is greater than a threshold load; and
a feedback assembly being operatively coupled to the processor, the processor being programmed to generate a feedback signal indicative of the compressive load being greater than the threshold load via the feedback assembly.

2. The apparatus of claim 1, wherein the lateral supports of the pair of lateral supports are pivotable between a deployed configuration wherein each lateral support extends rearwardly from the front panel and a folded configuration wherein the lateral supports extend toward each other.

3. The apparatus of claim 2, wherein the support frame further comprises a pair of support securement members, each support securement member of the pair of support securement members being mounted to the front panel and being engageable with an associated lateral support of the pair of lateral supports to secure the associated lateral support with respect to the front panel.

4. The apparatus of claim 3, wherein each support securement member of the pair of support securement members is rotatable with respect to the front panel to engage the associated lateral support in a clamping action.

5. The apparatus of claim 1, wherein each lateral support of the pair of lateral supports comprises a front leg, a rear leg, an upper crossbar, and a lower crossbar, the upper crossbar being coupled to and extending between upper ends of the front leg and the rear leg, the lower crossbar being coupled to and extending between the front leg and the rear leg below the upper crossbar.

6. The apparatus of claim 5, wherein each of the front leg and the rear leg is telescopically adjustable.

5. The apparatus of claim 1, wherein the support frame further comprises a pair of wheels, each wheel of the pair of wheels being rotatably coupled to an associated lateral support of the pair of lateral supports, each wheel of the pair of wheels comprising a resiliently compressible material such that the wheel is configured to conform to a shape of an obstruction.

6. The apparatus of claim 5, wherein each wheel of the pair of wheels defines a tread to frictionally enhance the wheel.

7. The apparatus of claim 1, wherein the support frame further comprises a pair of skids, each skid of the pair of skids being mounted to an associated lateral support of the pair of lateral supports.

8. The apparatus of claim 1, wherein the feedback assembly comprises a pair of haptic devices, each haptic device being mounted in an associated grip of the pair of grips, the pair of haptic devices being configured to generate a tactile signal.

9. The apparatus of claim 1, wherein the feedback assembly comprises a signal light source being mounted to an upper edge of the front panel, the signal light source being configured to emit a visible signal.

10. The apparatus of claim 1, wherein the feedback assembly comprises a speaker being mounted to the front panel, the speaker being configured to emit an audible signal.

11. The apparatus of claim 1, further comprising a guide light source being operatively coupled to the processor, the guide light source being oriented such that the guide light source is oriented such that the guide light is configured to emit light forwardly of the support frame.

12. The apparatus of claim 11, further comprising a light sensor being operatively coupled to the processor, the light sensor being mounted to the front panel, the processor being programmed to activate the guide light source when the light sensor detects a low brightness level.

13. The apparatus of claim 1, further comprising an accelerometer being operatively coupled to the processor, the accelerometer being mounted to the support frame, the processor being programmed to cause the feedback assembly to generate an alert signal when the accelerometer detects a tipping motion of the support frame.

14. The apparatus of claim 1, further comprising a transceiver being operatively coupled to the processor wherein the processor is configured to wirelessly communicate with a remote electronic device.

15. The apparatus of claim 14, further comprising a device mount being coupled to a rear side of the front panel, the device mount being configured to hold the remote electronic device.

16. The apparatus of claim 15, wherein the device mount comprises a base and a clamp, the base being coupled to the front panel, the clamp being pivotally coupled to the base, the clamp comprising a pair of hooks, the pair of hooks being biased to move toward each other wherein the pair of hooks is configured to clamp the remote electronic device.

17. The apparatus of claim 1, further comprising a power source being electrically couplable to the processor, the power source being removably mountable to the front panel to electrically couple to the processor, the power source comprising a battery.

18. A walker apparatus comprising:
a support frame comprising:
a front panel;
a pair of lateral supports being coupled to the front panel, each lateral support of the pair of lateral supports being positioned on an associated end of a pair of ends of the front panel, the pair of lateral supports being pivotable between a deployed configuration wherein each lateral support extends rearwardly from the front panel and a folded configuration wherein the lateral supports extend toward each other, each lateral support of the pair of lateral supports comprising a front leg, a rear leg, an upper crossbar, and a lower crossbar, the upper crossbar being coupled to and extending between upper ends of the front leg and the rear leg, the lower crossbar being coupled to and extending between the front leg and the rear leg below the upper crossbar, each of the front leg and the rear leg being telescopically adjustable;
a pair of grips, each grip being coupled to a top side of an associated lateral support of the pair of lateral supports;
a pair of support securement members, each support securement member of the pair of support securement members being mounted to the front panel and being engageable with an associated lateral support of the pair of lateral supports to secure the associated lateral support with respect to the front panel, each support securement member of the pair of support securement members being rotatable with respect to the front panel to engage the associated lateral support in a clamping action;
a pair of wheels, each wheel of the pair of wheels being rotatably coupled to a lower end of the front leg of an associated lateral support of the pair of lateral supports, each wheel of the pair of wheels comprising a resiliently compressible material such that the wheel is configured to conform to a shape of an obstruction, each wheel of the pair of wheels defining a tread to frictionally enhance the wheel; and
a pair of skids, each skid of the pair of skids being mounted to a lower end of the rear leg of an associated lateral support of the pair of lateral supports;
a processor being mounted to the support frame, the processor being positioned in the front panel;
a pair of load sensors being operatively coupled to the processor, each load sensor of the pair of load sensors being mounted to the lower end of the front leg of an associated lateral support of the pair of lateral supports, the pair of load sensors being configured to detect a compressive load exerted vertically on the support frame, the processor being programmed to determine when the compressive load is greater than a threshold load;
a feedback assembly being operatively coupled to the processor, the processor being programmed to generate a feedback signal indicative of the compressive load being greater than the threshold load via the feedback assembly, the feedback assembly comprising:
a pair of haptic devices, each haptic device being mounted in an associated grip of the pair of grips, the pair of haptic devices being configured to generate a tactile signal;
a signal light source being mounted to an upper edge of the front panel, the signal light source being configured to emit a visible signal; and
a speaker being mounted to the front panel, the speaker being configured to emit an audible signal;
a pair of guide light sources being operatively coupled to the processor, each guide light source of the pair of guide light sources being coupled to the lower end of the front leg of an associated lateral support of the pair of lateral supports, the pair of guide light sources being configured to emit light forwardly of the pair of wheels;
a light sensor being operatively coupled to the processor, the light sensor being mounted to the front panel, the processor being programmed to activate the pair of guide light sources when the light sensor detects a low brightness level;
an accelerometer being operatively coupled to the processor, the accelerometer being mounted to the support frame, the processor being programmed to cause the feedback assembly to generate an alert signal when the accelerometer detects a tipping motion of the support frame;
a transceiver being operatively coupled to the processor wherein the processor is configured to wirelessly communicate with a remote electronic device;
a device mount being coupled to a rear side of the front panel, the device mount comprising a base and a clamp, the base being coupled to the front panel, the clamp being pivotally coupled to the base, the clamp comprising a pair of hooks, the pair of hooks being biased to move toward each other wherein the pair of hooks is configured to clamp the remote electronic device; and
a power source being electrically couplable to the processor, the power source being removably mountable to the front panel to electrically couple to the processor, the power source comprising a battery.
